(19) United States
(12) Patent Application Publication
(10) Pub. No.: US 2024/0004708 A1
(43) Pub. Date: Jan. 4, 2024

(54) METHODS AND APPARATUS FOR ADAPTIVE PLATFORM POWER MANAGEMENT

(71) Applicants: Neal Conrad Oliver, Portland, OR (US); Ranganath Sunku, Beaverton, OR (US); Francesc Guim Bernat, Barcelona (ES); Kannan Babu Ramachari Ramia, Bangalore (IN); Gregory James Allison, Portland, OR (US)

(72) Inventors: Neal Conrad Oliver, Portland, OR (US); Ranganath Sunku, Beaverton, OR (US); Francesc Guim Bernat, Barcelona (ES); Kannan Babu Ramachari Ramia, Bangalore (IN); Gregory James Allison, Portland, OR (US)

(21) Appl. No.: 18/344,793

(22) Filed: Jun. 29, 2023

(51) Int. Cl. G06F 9/48

(52) U.S. Cl. CPC G06F 9/4893

(57) ABSTRACT

Systems, apparatus, articles of manufacture, and methods are disclosed for adaptive platform power management. These improve energy source management through switching energy sources of an edge node by incorporating memory, machine readable instructions, and processor circuitry to execute the functions of: evaluate operational parameters of a first energy source connected to a node and a second energy source connected to the node; determine an energy source to run a workload of the edge node based on a comparison of a first renewability to a second renewability, the evaluation of the operational parameters, and a power requirement of the workload, wherein the preferred energy source is the first energy source or the second energy source; and cause the edge node to switch to the preferred energy source.

### FIELD OF THE DISCLOSURE

This disclosure relates generally to management of edge nodes on a power grid and, more particularly, to energy source power management systems.

### BACKGROUND

In recent years, there has been a focus in the power industry to deploy advanced methods of utilizing renewable energy sources. Renewable energy is energy derived from natural sources that are replenished at a higher rate than they are consumed. While most conventional energy sources such as fossil fuels may be considered renewable to some extent, the relative ease of replenishment of some sources, such as sunlight and wind, has become a focal point for energy management techniques as those sources are constantly being replenished. The constant replenishment and generation of renewable energy sources typically creates less emissions than the generation of energy from conventional energy sources such as burning fossil fuels. However, the reliability of renewable energy sources is heavily dependent on their input (e.g., the amount of sunlight or wind accessible).

### BRIEF DESCRIPTION OF THE DRAWINGS

FIG. 1 is a block diagram of an example environment in which an example centralized edge resource orchestrator includes a power manager that operates to control power management for a plurality of edge nodes.

FIG. 2 is a block diagram of an example implementation of the power manager of FIG. 1.

FIG. 3 is a flowchart representative of example machine readable instructions and/or example operations that may be executed, instantiated, and/or performed by example programmable circuitry to implement the centralized edge resource orchestrator of FIG. 1.

FIG. 4A is a flowchart representative of example machine readable instructions and/or example operations that may be executed, instantiated, and/or performed by example programmable circuitry to implement the edge node of FIG. 1 when the power manager of FIG. 2 is implemented at the centralized edge resource orchestrator of FIG. 1.

FIG. 4B is a flowchart representative of example machine readable instructions and/or example operations that may be executed, instantiated, and/or performed by example programmable circuitry to implement the edge node of FIG. 1 when the power manager of FIG. 2 is implemented at the edge node of FIG. 1.

FIG. 5 is a flowchart representative of example machine readable instructions and/or example operations that may be executed, instantiated, and/or performed by example programmable circuitry to implement the power manager of FIG. 2.

FIG. 6 is a block diagram of an example processing platform including programmable circuitry structured to execute, instantiate, and/or perform the example machine readable instructions and/or perform the example operations of FIGS. 3-5 to implement the power manager of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, all energy is considered renewable and has an associated degree of renewability. Renewability may be measured relative to a natural renewability (e.g., how quickly the energy source may be replenished without significant human input) and/or may be measured relative to total renewability (e.g., how quickly the energy source can be renewed with human input). The higher the degree of renewability, the greater the rate at which the energy source is replenished relative to the rate at which the energy is consumed. Alternate terms for renewable energy are green energy (having a greenness), clean energy (having a cleanness), sustainable energy (having a sustainability), and replenishable energy (having a replenishability). For example, wind and solar energy are more renewable than energy derived from fossil fuels, as fossil fuels take millions of years to form naturally as compared to wind and sunlight which are constantly available.

CO2 equivalent may be utilized as a unit of measure for renewability or greenness. CO2 equivalent is a metric to compare CO2 emissions from various energy sources on the basis of their global-warming potential. The metric includes converting amounts of gases produced to the equivalent amount of carbon dioxide with the same global warming potential. As an example, wind energy produces around 11 grams of CO2 per kilowatt-hour, as compared to approximately 980 grams of CO2 per kilowatt-hour for coal. While CO2 measurement is described by way of example, a measure of any other type of emission from production of an energy source may be utilized (e.g., a measure of particulate matter, carbon emissions, etc.). Furthermore, the CO2 equivalent or other measurement may be based on a measurement of a producer of the actual energy source, may be a reference measurement, may be an average, mean, etc. measurement associated with a particular energy type, etc.

As used herein, the terms “energy” and “power” are used interchangeably. Energy is preferred in the sense of the conventional usage of “renewable energy” or “energy source”, whereas “power” is preferred when referring to elements of the invention.

### DETAILED DESCRIPTION

In a communications network, nodes are the connection points and endpoints for data transmissions or redistribution. A node sends, receives, stores, and/or creates information and communicates that data to other nodes in the network. Methods and apparatus are disclosed herein to manage the power distribution associated with nodes. Edge nodes are described herein as an example of nodes utilizing power distribution and energy management. The examples discussed herein may be utilized with other types of nodes, such as supervisor nodes, worker nodes, edge nodes, etc.

Distributed edge infrastructures encompass multiple edge computing nodes across various points or locations within a network. A distributed edge infrastructure may be deployed across vast regions such as mountains, distances far from cities, remote regions, or close to power plants. The infrastructure may cover a large geographic region, but its purpose is to enable edge nodes to operate with necessary autonomy close to end-users. In particular, edge orchestrators manage and coordinate resources within a network domain for multiple devices and amongst the connected infrastructure. Edge orchestrators attempt to automatically handle real-time network traffic and dynamic requests through efficient deployment of resources. Power grids include distributed edge nodes running on power generated by energy sources. In some instances, the edge nodes have multiple energy sources to provide a supply of power. Power management systems may manage the power distribution, or the energy source from which the edge node is getting power.

Methods and apparatus disclosed herein facilitate orchestration of power for edge nodes. For example, methods and apparatus disclosed herein control the utilization and/or supply of various power sources to balance characteristics of power generation and supply sources such as reliability, startup times and costs, running costs, capacity limitations, and switching characteristics such as interruptions or a lapses in power during switchover from one energy source to another. The example methods and apparatus disclosed herein work in conjunction with a centralized edge resource orchestrator to receive and interpret energy source and workload data, perform trend analysis, and make decisions to determine the workload distribution or energy source allocation.

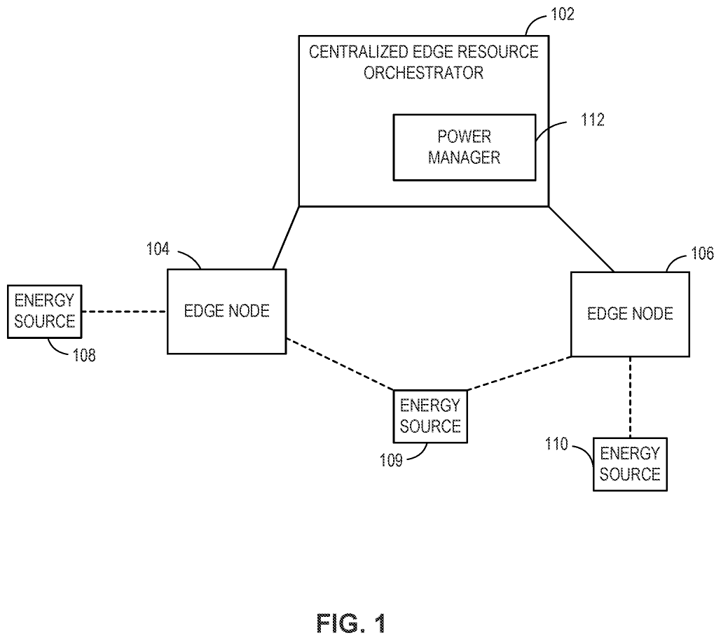

FIG. 1 is a block diagram of an example environment 100 in which an example centralized edge resource orchestrator 102 operates to manage example energy sources at each edge node 104, 106. To manage energy sources, the centralized edge resource orchestrator 102 uses a power manager 112 that uses data about the energy sources 108, 109, 110 and the edge nodes 104, 106 to determine which energy source 108, 109, 110 to utilize for the edge nodes 104, 106.

The example centralized edge resource orchestrator 102 is a system that manages the allocation and utilization of resources in an edge computing environment. The centralized edge resource orchestrator 102 monitors the resources such as example edge nodes 104, 106. The capabilities, location, and status of the available resources are monitored. The centralized edge resource orchestrator 102 decides where to deploy specific workloads based on factors such as the resource availability and/or capabilities. The centralized edge resource orchestrator 102 has the ability to distribute or redistribute workloads across the edge nodes 104, 106 to ensure proper efficient resource utilization. Additionally, the centralized edge resource orchestrator continuously monitors the performance and health of the edge nodes 104, 106 to make adjustments to resource utilization.

The example edge nodes 104, 106 are computing resources and/or devices located at the edge of a network. The edge nodes 104, 106 enable localized computation, data processing and analysis. The edge nodes are powered by energy sources 108, 109, 110 and are in communication with the centralized edge resource orchestrator 102.

The example energy sources 108, 109, 110 power the edge nodes 104, 106 in the network. An energy source 108, 109, 110 may be connected and dedicated to a single edge node, or may connected to multiple edge nodes 104, 106. Energy sources derive power to power the edge nodes from naturally occurring sources, such as fossil fuels, wind, solar, or water.

The example power manager 112 is a device that processes input data about power sources and targets, makes interpretations and decisions based on logic processing the data, analyzes trends about the data, and sends power control instructions based on the decisions.

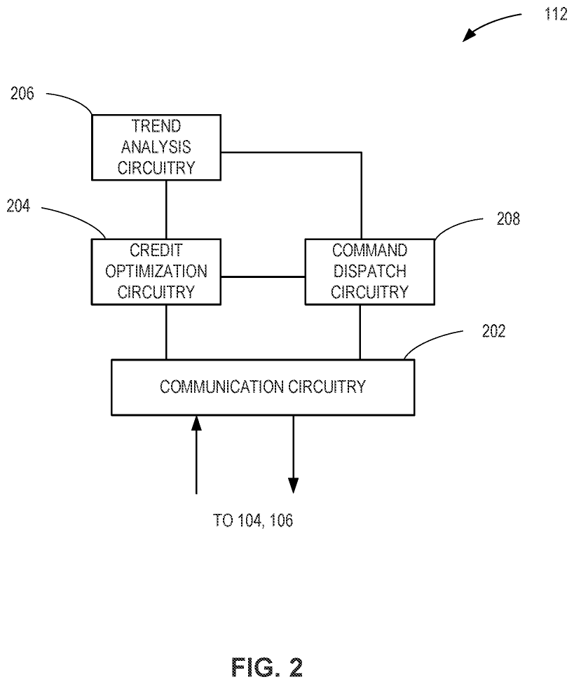

FIG. 2 demonstrates an example implementation of the power manager 112. Within the example power manager 112, the example communication circuitry 202 communicates between an edge node 104, 106 and the centralized edge resource orchestrator 102, or between the edge node 104, 106 and the energy sources 108, 109, 110. The example communication circuitry 202 converts incoming signals into usable data for a credit optimization circuitry 204. The example communication circuitry 202 also converts and outputs usable energy source switching instructions after receiving them from an example command dispatch circuitry 208.

The example credit optimization circuitry 204 processes input data about connected energy sources 108, 109, 110 and workloads on an edge node 104, 106. A credit system is used by the example credit optimization circuitry 204 to establish values and evaluate a figure of merit. The credit system computes credits, which are computed from the renewability, reliability and capacity scores of a power source as well as the priority and resource requirements of a workload. Credits increase when high renewable power sources are used up to their capacity, as well as when high-priority workloads are associated with power sources that are reliable and have high degrees of renewability. The example credit optimization circuitry 204 makes decisions about which energy source 108, 109, 110 to utilize to run a given workload so as to increase the credits in the edge network.

The example trend analysis circuitry 206 is circuitry that works in conjunction with the example credit optimization circuitry 204 to analyze trends in the input data and credits. The example trend analysis circuitry 206 ensures that capacity or capability of an energy source are always sufficient for a given workload.

The example command dispatch circuitry 208 is circuitry that converts the logic decisions and trending decisions made by the example credit optimization circuitry 204 and example trend analysis circuitry 206 to instructions for an edge node 104, 106 to switch which energy source 108, 109, 110 is providing power to the edge node 104, 106.

FIG. 2 is a block diagram of an example implementation of the power manager 112 of FIG. 1 to perform data processing, trend analysis, and dispatch relevant commands regarding the energy sources connected to a centralized edge resource orchestrator (e.g., the centralized edge resource orchestrator 102 of FIG. 1). The example power manager 112 of FIG. 2 includes an example communication circuitry 202, an example credit optimization circuitry 204, an example trend analysis circuitry 206, and an example command dispatch circuitry 208. The power manager of FIG. 2 may be instantiated (e.g., creating an instance of, bring into being for any length of time, materialize, implement, etc.) by programmable circuitry such as a Central Processor Unit (CPU) executing first instructions. Additionally or alternatively, the power manager of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In FIG. 2, an example communication circuitry 202 to communicate with edge nodes 104, 106 of FIG. 1 is shown within the context of the power manager 112. The example communication circuitry 202 receives data sent from the edge nodes 104, 106. The data is passed from the communication circuitry to an example credit optimization circuitry 204. The example communication circuitry 202 also receives commands from a command dispatcher 208.

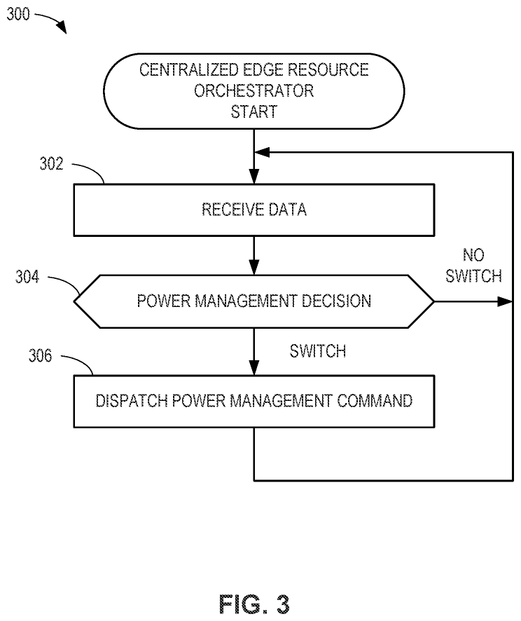

In some examples, the communication circuitry 202 is instantiated by programmable circuitry executing communication instructions and/or configured to perform operations such as those represented by the flowchart(s) of FIG. 3.

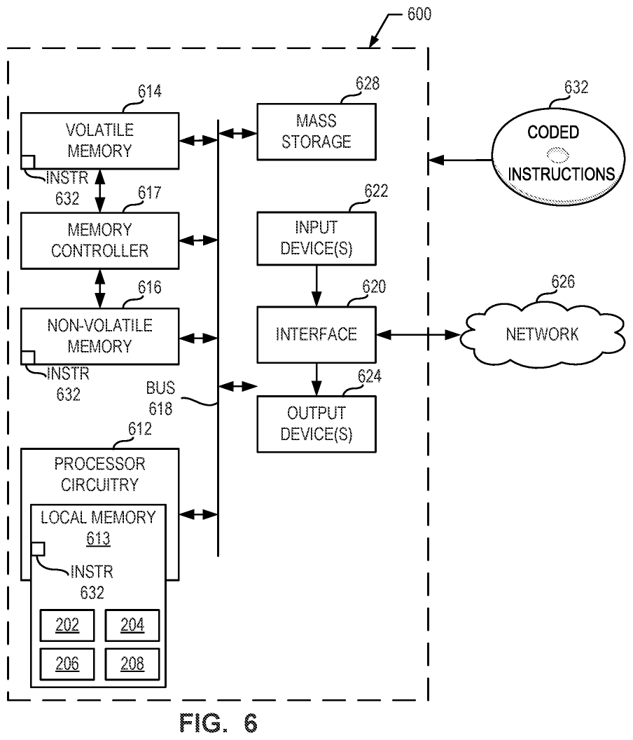

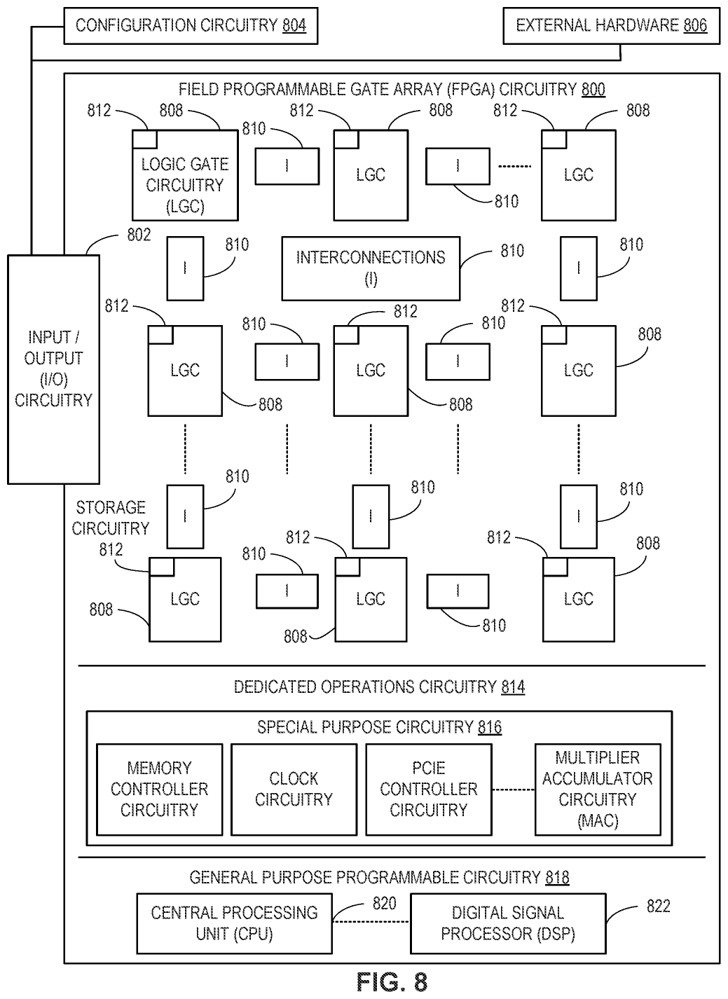

In some examples, the apparatus includes means for communicating with the edge nodes 104, 106. For example, the means for communicating may be implemented by communication circuitry 202. In some examples, the communication circuitry 202 may be instantiated by programmable circuitry such as the example programmable circuitry 612 of FIG. 6. For instance, the communication circuitry 202 may be instantiated by the example microprocessor 600 of FIG. 6 executing machine executable instructions such as those implemented by at least blocks 306, 306 of FIG. 3. In some examples, the communication circuitry 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the communication circuitry 202 may be instantiated by any other combination of hardware, software, and/or firmware. For example, the communication circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example credit optimization circuitry 204 of FIG. 2 obtains data from the communication circuitry 202. The credit optimization circuitry 204 processes the data. In this example, various credits are assigned to the different input data to come up with a figure of merit indicating the overall usability of the energy source connected. For example, the credit optimization circuitry 204 will track what type of energy source 108 is connected to an example edge node 104. If the energy source 108 is a renewable energy source such as a solar power, hydroelectric power, or wind power source, the credit optimization circuitry 204 assigns a credit to the source. In this example, a renewable energy source 108 such as solar power would be assigned more credit than a less renewable energy source 109 such as a fossil fuel source (e.g., coal power plant).

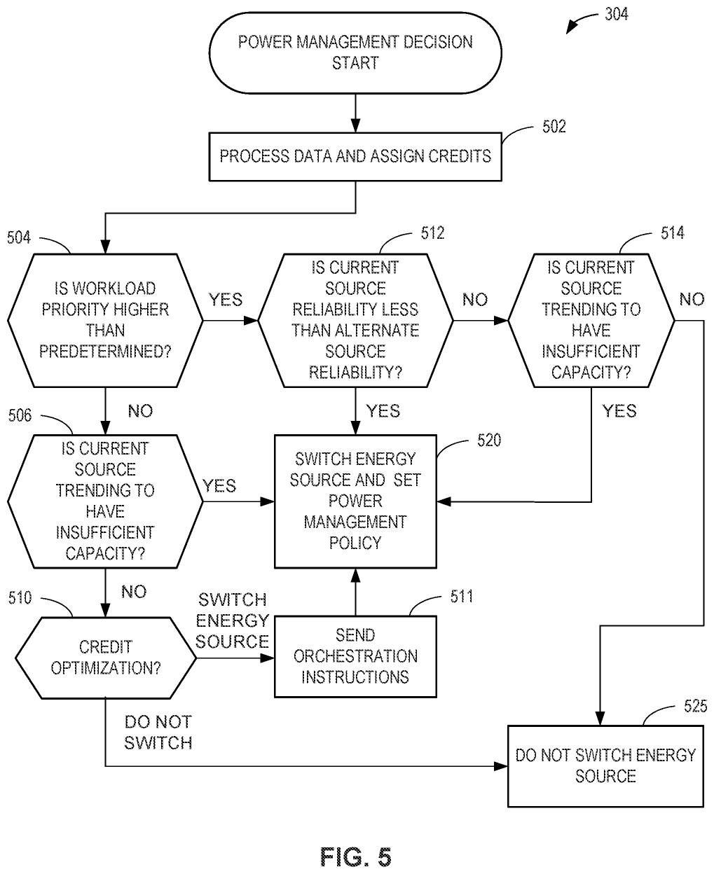

In some examples, the credit optimization circuitry 204 is instantiated by programmable circuitry executing credit optimization instructions and/or configured to perform operations such as those represented by the flowchart(s) of FIG. 5.

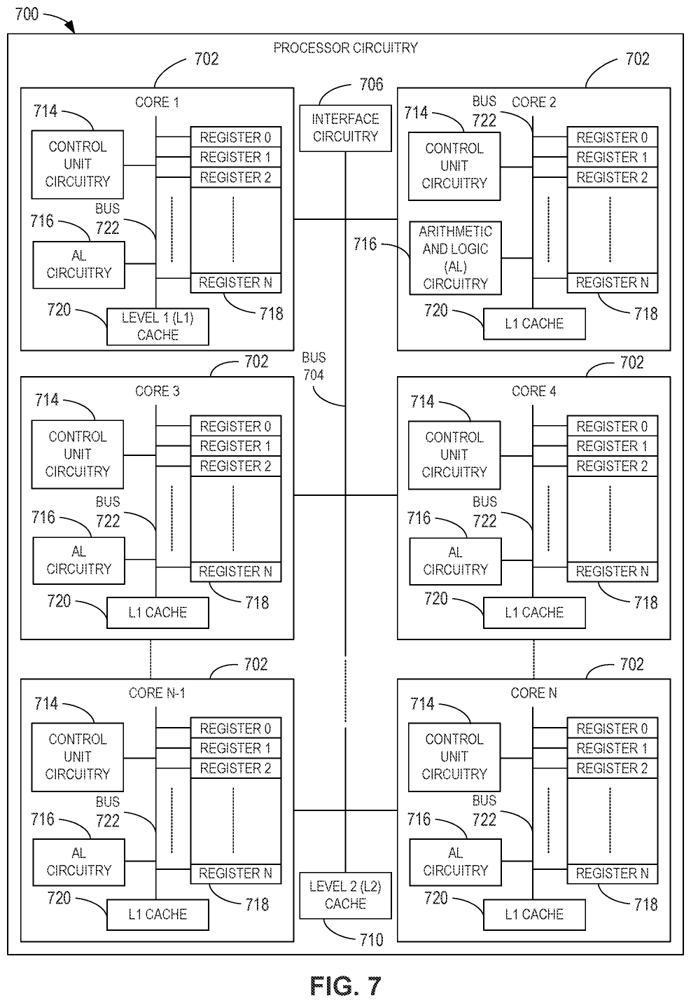

In some examples, the apparatus includes means for optimizing credits assigned to a power management data. For example, the means for determining may be implemented by credit optimization circuitry 204. In some examples, the credit optimization circuitry 204 may be instantiated by programmable circuitry such as the example programmable circuitry 612 of FIG. 6. For instance, the credit optimization circuitry 204 may be instantiated by the example microprocessor 700 of FIG. 7 executing machine executable instructions such as those implemented by at least blocks 502, 504, 510. 512 of FIG. 5. In some examples, the credit optimization circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the credit optimization circuitry 204 may be instantiated by any other combination of hardware, software, and/or firmware. For example, the credit optimization circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example power manager 112 includes the example trend analysis circuitry 206 to perform data analysis on the stored data in the credit optimization circuitry 204. For example, if an energy source 108, 109, 110 has a capacity that is depleting over time, the example trend analysis circuitry 206 stores those values and compares the capacity projected trend to a predetermined threshold. When the projected capacity is below the predetermined threshold, the example trend analysis circuitry 206 will signal a command dispatcher 208 to send the instructions to switch energy sources 108, 109, 110.

In some examples, the trend analysis circuitry 206 is instantiated by programmable circuitry executing trend analysis instructions and/or configured to perform operations such as those represented by the flowchart(s) of FIG. 5.

In some examples, the apparatus includes means for analyzing a trend of the power management data. For example, the means for determining may be implemented by trend analysis circuitry 206. In some examples, the trend analysis circuitry 206 may be instantiated by programmable circuitry such as the example programmable circuitry 612 of FIG. 6. For instance, the trend analysis circuitry 206 may be instantiated by the example microprocessor 700 of FIG. 7 executing machine executable instructions such as those implemented by at least blocks 506, 514 of FIG. 5. In some examples, the trend analysis circuitry 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the trend analysis circuitry 206 may be instantiated by any other combination of hardware, software, and/or firmware. For example, the trend analysis circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Shown in FIG. 2 is the example command dispatch circuitry 208. The example command dispatch circuitry 208 works within the power manager to dispatch commands through the communication means 202 to the edge nodes 104, 106. In this example, if the credit optimization circuitry 204 or the trend analysis circuitry 206 suggest that an energy source switch is to be made at an edge node, command dispatch circuitry 208 sends the instructions to switch power sources to the edge nodes 104, 106.

In some examples, the command dispatch circuitry 208 is instantiated by programmable circuitry executing command dispatch instructions and/or configured to perform operations such as those represented by the flowchart(s) of FIG. 3.

In some examples, the apparatus includes means for dispatching commands for switching power sources and setting power management policies. For example, the means for dispatching commands for switching power sources and setting power management policies may be implemented by command dispatch circuitry 208. In some examples, the command dispatch circuitry 208 may be instantiated by programmable circuitry such as the example programmable circuitry 612 of FIG. 6. For instance, the command dispatch circuitry 208 may be instantiated by the example microprocessor 700 of FIG. 7 executing machine executable instructions such as those implemented by at least blocks 306 of FIG. 3. In some examples, the command dispatch circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the command dispatch circuitry 208 may be instantiated by any other combination of hardware, software, and/or firmware. For example, the command dispatch circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the power manager of FIG. 1 is illustrated in FIG. 2, one or more of the elements, processes, and/or devices illustrated in FIG. 2 may be combined, divided, re-arranged, omitted, eliminated, and/or implemented in any other way. Further, the communication circuitry, the credit optimization circuitry, the trend analysis circuitry, the command dispatch circuitry and/or, more generally, the example power manager of FIG. 2, may be implemented by hardware alone or by hardware in combination with software and/or firmware. Thus, for example, any of the communication circuitry, the credit optimization circuitry, the trend analysis circuitry, the command dispatch circuitry, and/or, more generally, the example power manager, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example power manager of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the power manager 112 of FIG. 2 and/or representative of example operations which may be performed by programmable circuitry to implement and/or instantiate the power manager 112 of FIG. 2, are shown in FIGS. 3-5. The machine readable instructions may be one or more executable programs or portion(s) of one or more executable programs for execution by programmable circuitry such as the processor circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example power manager 112 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, Golang, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc. the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc. the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to dispatch power management commands and set power management policies based on power management decisions when the power manager 112 is implemented at the centralized edge resource orchestrator 102. The example machine-readable instructions and/or the example operations 300 of FIG. 3 begin at block 302, at which the communication circuitry 202 within the power manager 112 of the centralized edge resource orchestrator 102 first receives data from an edge node 104, 106.

After the example communication circuitry 202 within the power manager 112 receives data from the edge nodes 104, 106, the example centralized edge resource orchestrator 102 relies on the score determination circuitry 204 and the example trend analysis circuitry 206 to make a power management decision as depicted in block 304 of FIG. 3. The power management decision is further shown in FIG. 5. The power management decision has two outcomes: to switch the energy source upon which the edge node runs and to set the power management policy for the edge node, or to not switch the energy source upon which the edge node runs.

If the power management decision of block 304 results in not switching the energy source upon which the edge node 104, 106 runs, the centralized edge resource orchestrator 102 and the power manager 112 within default back to block 302, where the communication circuitry 202 of the power manager 112 receives data to be input to the power management decision of block 304.

If the power management decision of block 304 results in switching the energy source upon which the edge node 104, 106 runs and setting the power management policy for the edge node 104, 106, the centralized edge resource orchestrator 102 and the power manager 112 within utilize the example command dispatch circuitry 208 to dispatch a power management command to the edge node 104, 106 as shown in block 306 of FIG. 3.

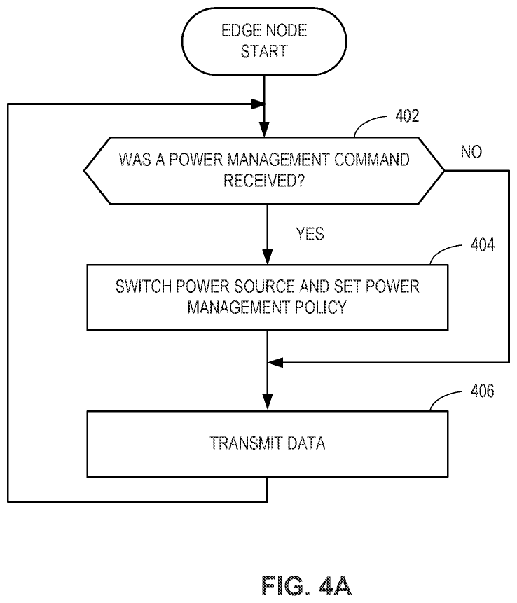

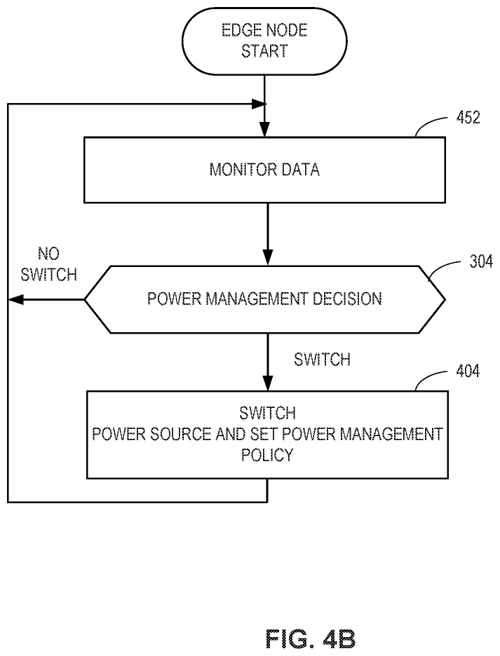

FIG. 4A is a flowchart representative of example machine readable instructions and/or example operations 400 that may be executed, instantiated, and/or performed by programmable circuitry to switch power and set power management policies based on power management decisions received when the power manager 112 is implemented at the centralized edge resource orchestrator. The example machine-readable instructions and/or the example operations 400 of FIG. 4A begin at block 402, at which the edge node 104, 106 first receives a power management command from the power manager 112 within the centralized edge resource orchestrator 102.

If the edge does not receive a power management command from the power manager 112 of the centralized edge resource orchestrator 102, the edge node 104, 106 defaults to transmitting data about the edge node and energy sources to which the edge node 104, 106 is connected. The data transmission operation is shown in block 406 of FIG. 4A.

If the edge does receive a power management command from the power manager 112 of the centralized edge resource orchestrator 102, the edge node 104, 106 switches the energy source upon which the edge node 104, 106 depends. The edge node 104, 106 also sets a power management policy associated with that type of energy source. The operations of switching the energy source and setting the power management policy are depicted as block 404 of FIG. 4A.

After switching the energy source and setting the power management policy as shown in block 404, the edge node 104, 106 returns to its default state of transmitting data related to the edge node 104, 106 and a plurality of energy sources 108, 109, 110 connected to the edge node 104, 106. The data transmission operation of the edge node is shown at block 406 of FIG. 4A.

FIG. 4B is a flowchart representative of example machine readable instructions and/or example operations 450 that may be executed, instantiated, and/or performed by programmable circuitry to make power management decisions and set power management policies based on the power management decisions when the power manager 112 is implemented at the edge node. The example machine-readable instructions and/or the example operations 450 of FIG. 4B begin at block 452, at which the power manager 112 of the edge node 104, 106 first monitors data related to an energy source 108, 109, 110 connected.

After the power manager 112 of the edge node 104, 106 monitors data, that data is used as input to a power management decision that is shown as block 304 of FIG. 4B. There are two potential outcomes to the decision: do not switch the energy source, or switch the energy source 108, 109, 110 and set the power management policy in accordance with the type of energy source 108, 109, 110 to be used. If the decision is to not switch the energy source 108, 109, 110, the power manager 112 of the edge node 104, 106 returns to monitoring data of the energy source 108, 109, 110 and edge node 104, 106, shown in block 452. If the power management decision 304 results in a decision to switch the energy source 108, 109, 110 and set the power management policy in accordance with the type of energy source 108, 109, 110 to be used, the edge node proceeds to the operation shown in block 404 of FIG. 4B, which is to switch the energy source 108, 109, 110 and to set the power management policy in accordance with the energy source 108, 109, 110 to be used.

FIG. 5 is a flowchart representative of example machine readable instructions and/or example operations 500 that may be executed, instantiated, and/or performed by programmable circuitry to determine whether or not the energy source 108, 109, 110 supplying the power to the edge node 104, 106 should be switched. The example machine-readable instructions and/or the example operations 500 of FIG. 5 begin at block 502, at which the credit optimization circuitry 204 within the power manager 112 of the centralized edge resource orchestrator 102 processes edge node 104, 106 and energy source 108, 109, 110 data.

In examples used herein, energy storage refers to an apparatus or method to store energy for short or long term storage. The energy storage may be any type of energy storage apparatus or methods, including but not limited to: flywheels, hydrogen storage, gravity batteries, ultra capacitors, flow batteries, etc. These energy storage methods and apparatus may be integrated into power grids to provide alternate power sources with shorter startup times, as well as greater stability and predictability as compared to conventional power sources.

The example credit optimization circuitry 204 begins at block 502 by processing input data about the edge node 104, 106 and energy source 108, 109, 110 acquired as assumptions, measured through telemetry, measured as energy storage capacity, or otherwise monitored. In this example, credits are assigned based on a variety of parameters, such as reliability, availability, cost, and greenness of the energy source. Consideration is given to the workload being run on the edge node 104, 106, which has an associated priority.

For example, edge node 106 can be powered by a first energy source 109 or a second energy source 110. The first energy source 109 is a highly renewable energy source, such as solar, hydroelectric, or wind. The second energy source 110 is a less renewable energy source, such as a coal powerplant. In this example, a new workload is introduced to the edge node 109. The workload has associated characteristics such as priority, power requirements, etc. Each energy source has an associated renewability, reliability, operational cost (startup cost, standby cost, and running cost), capacity, capability, distance to edge node, energy storage capacity, etc. All workload characteristics and energy source characteristics are processed as data and assigned credits in an example credit system.

The first decision made by the power manager 112, and more specifically the credit optimization circuitry 204, is deciding if the workload priority is higher than a predetermined threshold, as shown in block 504. By evaluating the workload priority, preference is given to high priority workloads so that the high priority workload has a reliable, high capacity, high capability energy source with a relaxed power management scheme so that high power levels can be run. If the workload priority is evaluated as higher than the predetermined threshold, the next evaluation occurs as shown in block 512. The evaluation shown in block 512 determines if the current energy source has a reliability less than an alternate available source. If the alternate available source has a reliability that is greater, the decision results in switching the power source and setting a power management policy (block 520). The example power management policy in this example is relaxed to provide freedom for applications on the edge node to utilize power states, as dictated by the priority predetermined threshold decision from block 504.

For example, a new workload is introduced to a first edge node 104. After processing the data associated with the connected energy sources 108, 109, the example credit optimization circuitry processes the data associated with the workload and establishes credits for running the workload on each energy source. The example credit optimization circuitry then evaluates the workload priority, and determines whether or not the priority is higher than a predetermined threshold.

In the instance the current source reliability evaluation of block 512 results in the current source being more reliable than the alternate source, the example trend analysis circuitry 206 evaluates trends in the capacity and capability of the energy sources 104, 106 as depicted in block 514. Block 514 shows the determination made by the example trend analysis circuitry 206 as to whether or not the current source is trending to have insufficient capacity and capability. If the current source is not trending to have insufficient capacity or capability, the example trend analysis circuitry makes the decision not to switch power sources, as shown in block 525. If the current source is trending to have insufficient capacity or capability (block 514), the example trend analysis circuitry sends a signal to the command dispatch circuitry that the power source needs to be switched and the power management policy needs to be set (block 520).

For example, a high priority workload is introduced to an edge node 106. As evaluated by the example credit optimization circuitry 204, the workload priority is higher than a predetermined threshold, resulting in an evaluation of a current energy source 110 reliability by the example credit optimization circuitry 204. Given the current energy source 110 being more reliable than an alternate source, the example trend analysis circuitry 206 evaluates the trend in capacity and capability of the current energy source 110. If the example trend analysis circuitry 206 evaluates the current source 110 as trending toward insufficient capacity or capability, the block 514 would evaluate as YES, and the example trend analysis circuitry 206 sends instructions to the example command dispatch circuitry 208 to switch energy sources and to set a power management policy in accordance with the workload and energy source operational parameters. In this example, the current source is not trending to have insufficient capacity or capability, resulting in NO from block 514. No instructions are sent to the example command dispatch circuitry 208 and the decision that results is depicted in block 525 as the energy source 110 is not switched.

If the workload priority evaluation of block 504 results in the workload priority being lower than the predetermined threshold, the example credit optimization circuitry 204 communicates with the example trend analysis circuitry 206 to have the example trend analysis circuitry 206 evaluate whether the current energy source 108, 109, 110 is trending to have insufficient capacity or capability, as shown in block 506. If the capacity or capability is trending to have insufficient capacity or capability, the example trend analysis circuitry 206 sends a signal to the example command dispatch circuitry 208 that the power source needs to be switched and the power management policy needs to be set (block 520).

If the capacity or capability is not trending to have insufficient capacity or capability (block 506), the example trend analysis circuitry 206 sends a signal to the example credit optimization circuitry 204 to perform credit optimization and orchestration (block 510).

For example, a low priority workload is connected to an example edge node 106. Decision block 504 and the credit optimization circuitry 204 determines that the priority is less than a predetermined threshold, leading to an analysis of the capacity and capability trends. The example trend analysis circuitry 206 evaluates the current energy source 110 powering the edge node 106. If the example energy source is trending to have insufficient capacity or capability, the example trend analysis circuitry 206 instructs the example command dispatch circuitry 208 to switch the energy sources and set the power management policy in accordance with the energy type and workload. In this example, the current energy source 110 is not trending to have insufficient capacity or capability. The example trend analysis circuitry 206 then communicates with the example credit optimization circuitry 204 to proceed with credit optimization.

Credit optimization and orchestration of block 510 includes logic to prioritize renewability of the associated energy sources. Operational parameters of the energy source are assigned credit values which count towards a figure of merit. The figure of merit is used to dictate which energy source is to be allocated to the workload on the edge node.

In the instance that an example workload is running on a first energy source that is less renewable than a second example energy source, the figure of merit is used to determine which energy source should be used to power the workload. If the credit optimization decision results in the current energy source being the preferred energy source for the current workload, a do not switch decision is made, and the action of not switching the energy source is taken (block 525). If the credit optimization decision results in an alternate energy source being the preferred energy source, a switch energy source decision is made leading to the credit optimization circuitry sending orchestration instructions in block 511. Sending the orchestration instructions is immediately followed by the result of switching the energy source and setting the power management policy, as shown in block 520.

In this example, the workload satisfies all criteria to get to the credit optimization and orchestration block 510 and is being run on a less renewable energy source. In this example, the second, more renewable energy source has a higher figure of merit. The comparison of the energy sources, their renewability, and the associated figures of merit causes a decision to switch the energy source from a non-preferred energy source (the first energy source) to the preferred energy source (the second energy source). At the credit optimization block 510, the decision output is switch the energy source. The example credit optimization circuitry then sends orchestration instructions (block 511) to ensure there is a transition of power without a lapse in power. In this example, the result is a decision that the example credit optimization circuitry switches the energy source and sets the power management policy.

FIG. 5 sets forth decision and prioritization blocks that may be instantiated by an infrastructure processing unit (IPU). An IPU is a programmable network device that is dedicated to handling specific tasks related to networking or infrastructure management. An IPU offloads and accelerates processing functions that are performed by general purpose processors or other specialized hardware components. In the example distributed edge network, offloading such operations to an IPU (or other type of processing unit) to operate the decision making algorithm described in conjunction in FIG. 5 enables benefits such as improved performance through reduced processing overhead, and increased efficiency as CPU performance for other computing tasks is freed-up.

FIG. 6 is a block diagram of an example programmable circuitry platform 600 structured to execute and/or instantiate the example machine-readable instructions and/or the example operations of FIGS. 3-5 to implement the power manager 112 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the communication circuitry 202, the command dispatch circuitry 208, the credit optimization circuitry 204, and the trend analysis circuitry 206.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612.

One or more output devices 624 are also connected to the interface circuitry 620 of the illustrated example. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 3-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 3-5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 3-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5. As such, the FPGA circuitry 800 may be configured and/or structured to effectively instantiate some or all of the operations/functions corresponding to the machine readable instructions of the flowchart(s) of FIGS. 3-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 3-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 3-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 3-5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 3-5, and/or an ASIC may be configured and/or structured to perform third operation(s)/function(s) corresponding to a third portion of the machine readable instructions represented by the flowcharts of FIGS. 3-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

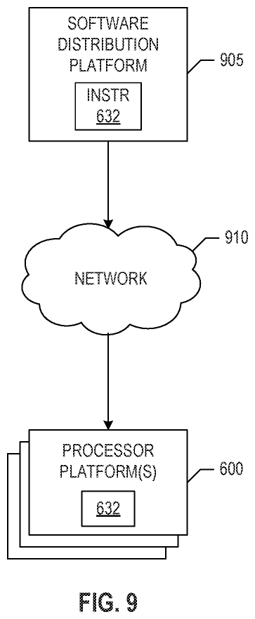

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 3-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 3-5, may be downloaded to the example programmable circuitry platform 600, which is to execute the machine readable instructions 632 to implement the power manager 112. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that cause an edge node to switch between energy sources, enabling greener energy sources to be utilized more often and in a more reliable manner. Disclosed systems, apparatus, articles of manufacture, and methods improve the efficiency of using a computing device by allocating more reliable energy sources to higher priority workloads, restricting power levels on less renewable energy sources, and utilizing more renewable energy sources with higher power levels to power workloads without priority demand. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage energy sources of an edge node are disclosed herein. Further examples and combinations thereof include the following:

Example 1 includes an apparatus to switch energy sources of an edge node comprising interface circuitry, machine readable instructions, and programmable circuitry to at least one of instantiate or execute the machine readable instructions to compare a first renewability of a first energy source connected to the edge node to a second renewability of a second energy source connected to the edge node, evaluate operational parameters of the first energy source and the second energy source, determine a preferred energy source to run a workload of the edge node based on the comparison of the first renewability to the second renewability, the evaluation of the operational parameters, and a power requirement of the workload, wherein the preferred energy source is the first energy source or the second energy source, and cause the edge node to switch to the preferred energy source.

Example 2 includes the apparatus of example 1, wherein a first energy source includes at least one of solar power, wind power, and hydroelectric power.

Example 3 includes the apparatus of example 1, wherein the operational parameters include at least one of capacity of the first energy source, capability of the first energy source, reliability of the first energy source, and cost of the first energy source.

Example 4 includes the apparatus of example 1, wherein determining the preferred energy source is based on a trend of the operational parameters.

Example 5 includes the apparatus of example 1, further including adjusting a power level of the preferred energy source based on the comparison of the first renewability to the second renewability, the evaluation of the operational parameters, and a power requirement of the workload.

Example 6 includes the apparatus of example 1, wherein switching to the preferred energy source is orchestrated to prevent a lapse in power supply at the edge node.

Example 7 includes the apparatus of example 1, further including causing a switch from the preferred energy source to a non-preferred energy source based on the preferred energy source running out of capacity.

Example 8 includes the apparatus of example 1, wherein the operational parameters are measured through live telemetry.

Example 9 includes the apparatus of example 1, wherein the edge node is a first edge node, and wherein the workload can be redistributed to a second edge node based on the operational parameters of the preferred energy source.

Example 10 includes a non-transitory computer readable medium comprising instructions to cause a machine to at least determine that first data indicative of a renewability of a first energy source indicates that the first energy source is more renewable than a second energy source, the first energy source associated with a first type of power generation and the second energy source associated with a second type of power generation, and cause an edge node to switch from the first energy source associated with the first type of power generation to the second energy source associated with the second type of power generation based on the first data indicative of the at least one of the renewability of the first energy source and second data indicative of a priority of a workload associated with the edge node.

Example 11 includes the non-transitory computer readable medium of example 10, wherein the first type of power generation includes at least one of solar power, hydroelectric power, and wind power.

Example 12 includes the non-transitory computer readable medium of example 10, wherein the instructions cause the machine to cause the edge node to switch from the first energy source to the second energy source further based on third data indicating a capacity of the first energy source.

Example 13 includes the non-transitory computer readable medium of example 10, wherein the instructions cause the machine to cause the edge node to switch from the first energy source to the second energy source further based on third data indicating a trend of a capacity of the first energy source.

Example 14 includes the non-transitory computer readable medium of example 10, wherein the instructions cause the machine to adjust a power level of the edge node based on the first data indicative of the renewability of the first energy source.

Example 15 includes the non-transitory computer readable medium of example 10, further including a determination that the first data indicates that the second energy source is more reliable than the second energy source, the reliability based on at least one of capacity, capability, or availability of the second energy source.

Example 16 includes the non-transitory computer readable medium of example 10, the edge node is a first edge node running a workload.

Example 17 includes the non-transitory computer readable medium of example 16, wherein the workload can be redistributed to a second edge node based on an operational parameter of the second energy source.

Example 18 includes the non-transitory computer readable medium of example 17, wherein the operational parameter is at least one of reliability, capacity, capability, and operational cost of the second energy source.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to switch energy sources to supply a node comprising:
interface circuitry;
machine readable instructions; and
programmable circuitry to at least one of instantiate or execute the machine readable instructions to:
evaluate operational parameters of a first energy source connected to the node and a second energy source connected to the node;
determine an energy source to run a workload of the node based on a comparison of a first renewability of the first energy source to a second renewability of the second energy source, the evaluation of the operational parameters, and a power requirement of the workload, wherein the energy source is the first energy source or the second energy source; and
cause the node to switch to the energy source.

2. The apparatus of claim 1, wherein the first energy source includes at least one of solar power, wind power, and hydroelectric power.

3. The apparatus of claim 1, wherein the operational parameters include at least one of capacity of the first energy source, capability of the first energy source, reliability of the first energy source, and cost of the first energy source.

4. The apparatus of claim 1, wherein determining the energy source is based on a trend of the operational parameters.

5. The apparatus of claim 1, further including adjusting a power level of the energy source to run the workload based on the comparison of the first renewability to the second renewability, the evaluation of the operational parameters, and a power requirement of the workload.

6. The apparatus of claim 1, wherein switching to the energy source to run the workload is orchestrated to prevent a lapse in power supply at the node.

7. The apparatus of claim 1, further including causing a switch from the energy source running the workload to a different energy source based on the energy source running the workload running out of capacity.

8. The apparatus of claim 1, wherein the operational parameters are measured through live telemetry.

9. The apparatus of claim 1, wherein the edge node is a first edge node, and wherein the workload can be redistributed to a second edge node based on the operational parameters of the preferred energy source.

10. A non-transitory computer readable medium comprising instructions to cause a machine to at least:
determine that first data indicative of a renewability of a first energy source indicates that the first energy source is more renewable than a second energy source, the first energy source associated with a first type of power generation and the second energy source associated with a second type of power generation; and
cause a node to switch from the first energy source associated with the first type of power generation to the second energy source associated with the second type of power generation based on the first data indicative of the at least one of the renewability of the first energy source and second data indicative of a priority of a workload associated with the node.

11. The non-transitory computer readable medium of claim 10, wherein the first type of power generation includes at least one of solar power, hydroelectric power, and wind power.

12. The non-transitory computer readable medium of claim 10, wherein the instructions cause the machine to cause the node to switch from the first energy source to the second energy source further based on third data indicating a capacity of the first energy source.

13. The non-transitory computer readable medium of claim 10, wherein the instructions cause the machine to cause the node to switch from the first energy source to the second energy source further based on third data indicating a trend of a capacity of the first energy source.

14. The non-transitory computer readable medium of claim 10, wherein the instructions cause the machine to adjust a power level of the node based on the first data indicative of the renewability of the first energy source.

15. The non-transitory computer readable medium of claim 10, further including a determination that the first data indicates that the second energy source is more reliable than the second energy source, the reliability based on at least one of capacity, capability, or availability of the second energy source.

16. The non-transitory computer readable medium of claim 10, the node is a first node running a workload.

17. The non-transitory computer readable medium of claim 16, wherein the workload can be redistributed to a second node based on an operational parameter of the second energy source.

18. The non-transitory computer readable medium of claim 17, wherein the operational parameter is at least one of reliability, capacity, capability, and operational cost of the second energy source.
